(19) United States
(12) Patent Application Publication
(10) Pub. No.: US 2008/0170934 A1
(43) Pub. Date: Jul. 17, 2008

(54) Handling Device For Boxes and the Like

(75) Inventor: Jean Labadie, Laval (FR)

Correspondence Address: YOUNG & THOMPSON, 209 Madison Street, Suite 500, ALEXANDRIA, VA, 22314, US

(73) Assignee: LABADIS, Laval (FR)

(21) Appl. No.: 10/569,489

(22) PCT Filed: Sep. 9, 2004
(86) PCT No.: PCT/FR2004/002287

§ 371 Date: Feb. 24, 2006

(30) Foreign Application Priority Data
Sep. 10, 2003 (FR) 03/10651

(51) Int. Cl. B65G 65/00

(52) U.S. Cl. 414/788.9

(57) ABSTRACT

A handling device for boxes and the similar repeatedly presents the top box of a first box pile (11) at a predetermined height and making it possible to remove the top box in such a way that the removed boxes of the first pile (11) gradually form a second pile (12) includes a first vertically movable support (9) for receiving the first pile (11), a second vertically movable support (10) for receiving the second pile (12), a device for synchronously controlling the supports (9, 10) by way of at least one of them when one goes up and the other goes down and vice-versa. The handling device is arranged in such a way that the top box of the first pile (11) is transferable directly to the second pile (12) by lateral displacement at a more or less permanent level.

The invention relates to the field of handling containers such as boxes or bins.

It relates more particularly to a handling device intended to dispose boxes at a convenient height for an operative to be able to take parts that he requires therefrom and equally intended to enable the evacuation and the replacement of boxes, once emptied, by full boxes.

Devices of the above type are employed in particular at the various stations of an assembly line. If an operative or a machine is to perform an assembly operation quickly and efficiently, it is necessary to have parts to be assembled available in such a manner that they are easily accessible and situated in the vicinity of the workstation.

Furthermore, it is necessary to provide for storage of the parts at the workstation and for handling the means intended to contain them, in particular for evacuating such means.

Handling means of the above kind including a central column and two supports mounted on respective opposite sides of the column and movable in vertical translation along the column are known in the art. One of the supports is mounted on a motorized screw attached to the column while the other support is mounted on a simple slideway and is connected to the other support by a cable co-operating with a pulley at the top of the column.

A handling device of the above kind enables a stack of boxes full of parts to be loaded onto the first support and the first box to be placed at a predetermined height accessible to the operator.

Once the first box has been emptied of its parts, it is transferred manually to the second support over the top of the column and the second box of the stack of full boxes becomes accessible.

Handling devices of the above kind are satisfactory in terms of making full boxes available.

The object of the invention is nevertheless to improve the above type of handling device by providing a device to facilitate transferring bins from one support to the other.

To this end, the invention proposes a handling device for boxes and the like for repeatedly presenting the top box of a first stack of boxes at a predetermined height and making it possible to remove said top box in such a way that the boxes removed from the first stack gradually form a second stack, this device comprising:
a first vertically movable support for receiving said first stack;
a second vertically movable support for receiving said second stack; and
means for synchronously driving the first and second supports so that when one goes up the other goes down and vice versa;
   which handling device is characterized in that it further includes a first lateral upright and a second lateral upright separate from the first upright each provided with a slideway, the first support being mounted on the slideway of the first upright and the second support being mounted on the slideway of the second upright, the device being adapted to leave free the gap between the second upright and said top box of the first stack at the predetermined height so that the top box of the first stack is transferable directly to the second stack by lateral displacement at a more or less permanent level.

A handling device of the above kind aligns the stacks of boxes so that the first box of one stack can be transferred to the other stack by a simple gesture of the operator or by an actuator.

A handling device of the above kind is therefore adapted to increase the productivity of a workstation by making a box of parts available continuously and by easy and fast evacuation of empty boxes with little downtime.

The supports may further be adapted to occupy a mid-height position in which they are disposed face-to-face at more or less the same level.

When said stacks of boxes are on trolleys, which is routine in this type of application, the device of the invention also facilitates transfer of the trolley from one support to another, in particular when the latter are in their mid-height position.

In one embodiment, the synchronized drive means include a cable each of the ends whereof is connected to a respective one of the supports and which travels along a guide path including two bottom idler pulleys each disposed at the base of a respective one of the lateral uprights and two top idler pulleys each disposed at the top of a respective one of the lateral uprights, the portion of the guide path situated between the bottom idler pulleys being substantially horizontal and disposed under said supports so that the assembly formed by the two supports is partially surrounded by the guide path.

This mechanical implementation of said synchronized drive means makes the device particularly reliable.

The handling device may further include at least one motor co-operating with transmission means connected to the synchronized drive means to drive movement of the first and second supports.

According to a preferred feature, said transmission means connect the motor to one of the supports so that the movement of said support are driven directly by the motor, the movement of the other support being driven by the synchronized drive means.

This is a particularly economical embodiment using, thanks to the synchronized drive means, a single motor.

In this case, said transmission means may include a transmission screw adapted to be driven in rotation by the motor, the support being connected to a threaded member meshing with the transmission screw.

According to a preferred feature, at least one of the idler pulleys is mounted on a mobile shaft allowing movement of the pulley and modification of the length of the guide path.

To be more precise, one of the top idler pulleys may be mounted so as to be mobile substantially vertically relative to the corresponding lateral upright.

Advantageously, one of the top idler pulleys may be connected to a threaded member meshing with an adjuster screw rotatably mounted on the corresponding lateral upright, the adjuster screw being connected to drive means accessible from said lateral upright.

The height of the cable tray can therefore be adjusted so that the first box of the first stack may be positioned at the height required for transfer to the other stack.

Moreover, boxes of different heights can then be used with the same handling device.

The handling device advantageously further includes a control module for the synchronized drive means and at least one sensing member connected to said control module, which is adapted to control the synchronized drive means as a function of indications supplied by the sensing member.

The sensing member may be a member for sensing the height of the first stack, a member for sensing the height of the second stack and/or a support sensing member adapted to supply an indication to the control module when the two supports are face-to-face.

Thus the handling device is partly automated. One of the stacks is raised and the other lowered, automatically, as and when the boxes are emptied and transferred from one stack to the other.

According to a preferred feature, the device includes a safety stop member mounted under at least one of said supports and including stop means for the supports.

A stop device of this kind allows safe operation of the device without using covers or barriers that impede operations.

According to another embodiment of the invention, the synchronized drive means include two motors each disposed on one of the lateral uprights, to enable independent movement of each support.

Each lateral upright having its own drive motor, it is no longer necessary to provide any transmission device between the lateral uprights, the thickness of which may therefore be reduced.

According to a preferred feature of this embodiment, the supports are further adapted to occupy a high position in which they are disposed face-to-face at more or less the same level.

When the boxes are stacked on trolleys, the device facilitates transfer of the trolley from one support to the other by a person standing in an ergonomic posture.

Each support may be attached to the first end of a flexible connection whose second end is attached to the motor so that winding in of the second end of the flexible connection by the motor raises the support.

This improves safety in that, during the descent of a support, the flexible connection enables the support to exert no force other than its own weight on an obstacle, in particular a portion of the body of the operative.

According to a preferred feature, the motor includes a winder adapted to enable the second end of the flexible connection to be wound up on itself by the motor so that during winding the winding diameter increases.

This kind of winder enables the motor to operate at constant torque in that, given the way the device operates, one support rises as and when boxes are removed from the stack it is carrying. In other words, the lower a support, the greater the load that the motor has to raise, and the higher a support, the lower the load to be raised.

The winder operates with a low winding diameter when a support is low, the torque supplied by the motor enabling large loads to be raised. Conversely, when a support is high, the winding diameter is greater and the motor, operating at the same torque, is then adapted to raise lower loads. Consequently it is not necessary to use a variable speed drive associated with the motor.

The flexible connection advantageously includes a strap forming the second end of the flexible connection.

The handling device may further include a control module of the synchronized drive means and at least one sensing member connected to said control module, which controls the synchronized drive means as a function of the indications supplied by the sensing member.

This enables the handling device to be automated.

Two sensing members may therefore be used with one disposed on each of the lateral uprights and each adapted to sense the height of the corresponding stack.

The sensing members enable accurate alignment of the stacks carried by the supports to facilitate lateral translation from the first stack to the second stack.

Other features and advantages of the invention will become apparent in the light of the following description of a nonlimiting preferred embodiment, which description is given with reference to the appended drawings, in which:

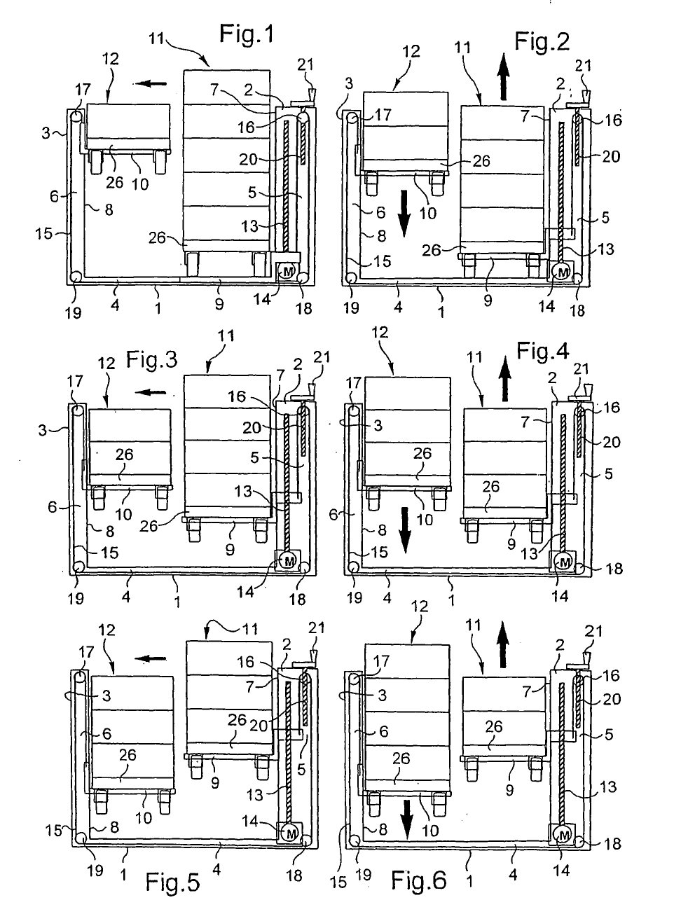

FIG. 1 is a front view, in section, of a first embodiment of a handling device of the invention in a cycle start configuration: the first box of the first stack (top right) has been emptied and transferred to the second stack;

FIG. 2 shows the step following FIG. 1: the first stack rises and the second stack descends to level the boxes again;

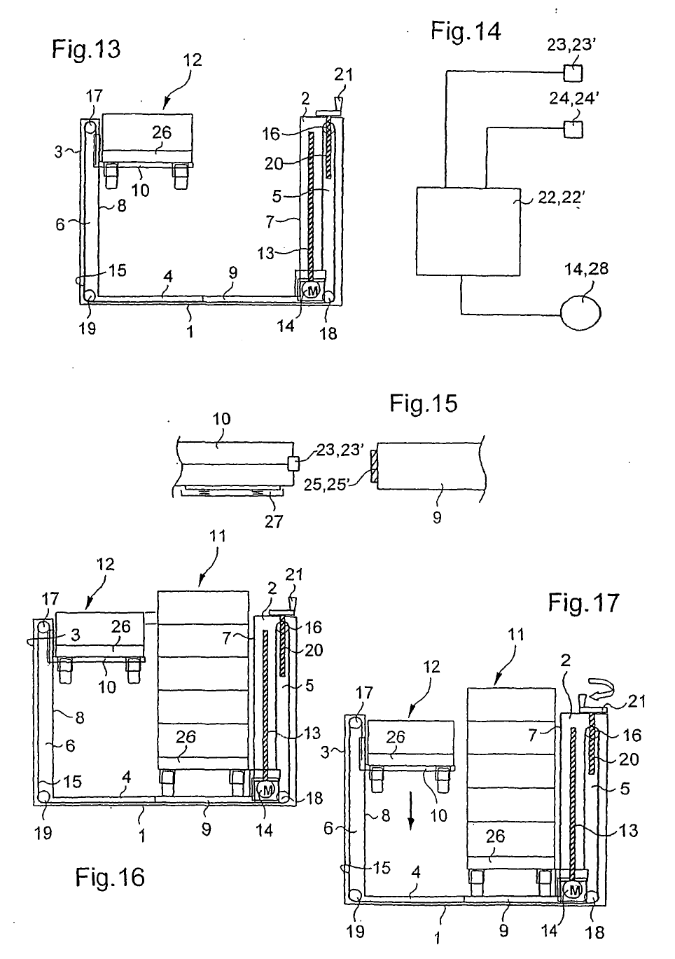

FIGS. 3 to 13 show, in the manner of FIGS. 1 and 2, the successive steps of the operation of the FIG. 1 handling device, FIG. 13 representing an end of cycle configuration;

FIG. 14 is a schematic representing a motor, a motor control module and sensors forming part of the handling device of the invention;

FIG. 15 is an enlarged view of a portion of that device inside the box XV in FIG. 12;

FIGS. 16 and 17 show the possible adjustment of the length of the cable tray of the device from FIGS. 1 to 13;

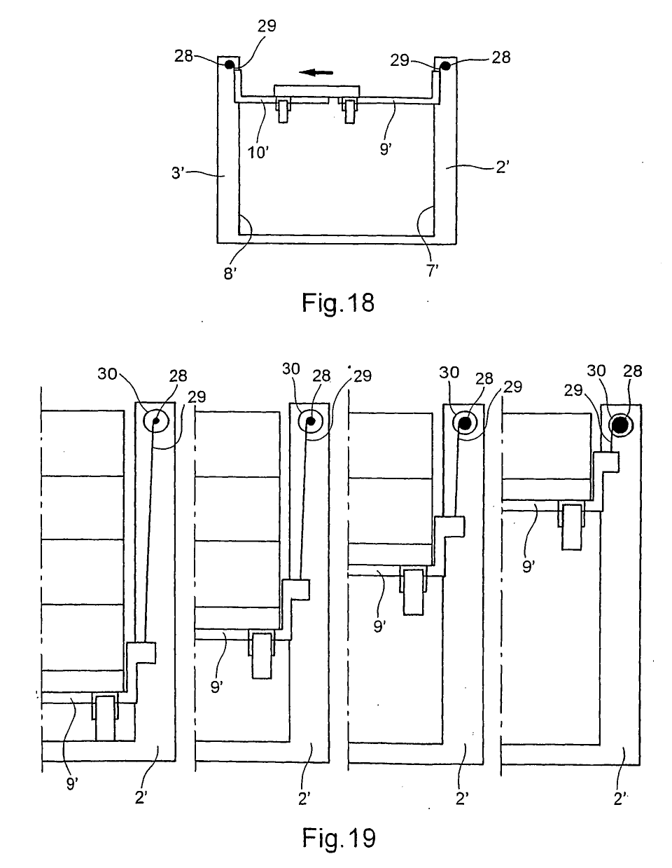

FIG. 18 is a front view, in section, of a second embodiment of a handling device of the invention, the two supports being face-to-face; and

FIG. 19 is a diagram showing four successive partial views of one of the uprights of the FIG. 18 handling device, these views showing the steps of the raising of a trolley.

The handling device represented in FIGS. 1 to 13 includes a horizontal platform 1 attached to two vertical lateral uprights 2, 3.

The platform 1 is intended to rest on the floor or on any other support, possibly on feet (not shown). It includes a hollow portion between the two uprights 2, 3 defining a guide path portion 4.

The uprights 2, 3 each have a hollow portion defining a guide path portion 5, 6 communicating with the guide path portion 4 of the platform 1.

The three portions defined above form a guide path 4, 5, 6.

Each of the uprights 2, 3 includes a slideway 7, 8 on which is slidably mounted a support 9, 10 adapted to receive a stack of boxes 11, 12.

The stacks of boxes 11, 12 can co-operate with the supports 9, 10 directly or, as shown in the figures, through a trolley 26 that is more convenient for moving the stacks 11, 12.

The supports 9, 10 may be of the forked type or the type having a plane surface and their dimensions are advantageously adapted so that they can be inserted between the wheels of the trolleys 26.

Moreover, the supports 9, 10 may enter housings in the platform 1 so that when a support 9, 10 is lowered completely it forms a plane surface with the platform 1 (see FIG. 1).

For convenience of description, the expression “first stack of boxes 11” designates a stack of full boxes and the expression “second stack of boxes 12” designates a stack of empty boxes. Similarly, the expressions “first lateral upright 2”, “first slideway 7” and “first support 9” designate the members co-operating with the first stack of boxes 11 and the expressions “second lateral upright 3”, “second slideway 8” and “second support 10” designate the members co-operating with the second stack of boxes 12.

The slideways 7, 8 and the supports 9, 10 are disposed so as to be able to raise the stacks of boxes 11, 12 vertically. To this end, the first upright 2 includes a vertical screw 13 disposed longitudinally along the upright 2 and connected to a threaded portion of the support 9.

One end of the screw 13 is connected to a motor 14 which therefore drives the support 9 up and down the slideway 7.

Mechanical connecting means are also provided to synchronize the movements of the two supports 9, 10. A cable 15 follows the guide path 4, 5, 6 defined by two top pulleys 16, 17 and two bottom pulleys 18, 19 and has a first end connected to the first support 9 and a second end connected to the second support 10.

The cable 15 follows the following path:
it extends from the first support 9 to the upper portion of the first upright 2;
after the top pulley 16, it returns to the bottom of the first upright 2;
after the bottom pulley 18, it crosses the platform 1 horizontally;
having returned to the second upright 3, after the bottom pulley 19, it extends the entire length of the second upright 3;
after the top pulley 17, it returns to the second support 10.

When the first support 9 is raised (respectively lowered) a certain distance by the motor 14, the second support 10 is therefore lowered (respectively raised) by the same distance.

Referring to FIGS. 16 and 17, the spindle of the top pulley 16 of the first upright 2 is mounted on a support driven vertically by an adjuster screw 20. This screw 20 is operated by a rotary crank handle 21 for accurate manual adjustment of the height of the pulley 16 and therefore adjustment of the length of the guide path 4, 5, 6 to define the relative position of the supports 9, 10.

To be more precise, this adjustment adapts the handling device to different box heights, as explained hereinafter.

The handling device further includes a control circuit shown diagrammatically in FIG. 14.

Note that in FIGS. 14 and 15, when two reference numbers are placed side by side, that to the left of the comma relates to the embodiment otherwise shown in FIGS. 1 to 17 and that to the right of the comma relates to the embodiment otherwise shown in FIGS. 18 and 19.

The output of a control module 22 such as an industrial programmable controller is connected to the motor 14 and its input receives information from a support sensor 23 and a box sensor 24, for example optical sensors.

The support sensor 23 is intended to supply an indication of alignment or non-alignment of the facing supports 9, 10. It may be arranged as shown in FIG. 15, which shows a detail from FIG. 12, the sensor 23 being fixed to the end of a support 3 and a reflector 25 being fixed to the end of the other support 2. The control module 22 is able to detect alignment of the sensor 23 and the reflector 25.

The box sensor 24 is intended to supply information indicating the presence or the absence of a box in front of it. It may be placed on the first upright 2 or the second upright 3.

The handling device also has a safety stop member 27 adapted to operate a switch for stopping the motor 14 (FIG. 15). This member 27 is mounted under one or both of the supports 9, 10 so that, if the support 10 encounters an obstacle while being lowered, it trips the safety stop member 27 and stops the motor 14.

A complete cycle of the operation of the handling device is described next.

First of all, the cable tray must be adjusted as a function of the height of the boxes to be used, as shown in FIGS. 16 and 17. A first stack of boxes 11 is placed on the support 9 and a second stack of boxes 12, here including only one box, is placed on the second support.

The handle 21 is then operated, which moves the second support 10, until the joints between two boxes of each stack 11, 12 coincide. Here (FIG. 17) it is a question of aligning the top of the box of the second stack 12 with the joint between the top two boxes of the first stack of boxes 11, although a difference in level of a few centimeters is nevertheless acceptable.

With reference to the steps represented in FIGS. 1 to 13, the cycle may begin with an empty box and its trolley 26 on the second support 10 and with a stack 11 of full boxes and its carriage 26 on the first support 9.

The handling device is positioned near the workstation using the parts contained in the boxes.

The workstation is arranged so that it is convenient for an operative or a machine to pick parts in a reference location occupied by the first box (that at the top) of the first stack 11. The handling device is adapted to evacuate said first box, once emptied of parts, to the second stack 12 and then to position the next box of the first stack 11 at the reference location.

Once the first box of the first stack 11 is empty, it is moved in translation, manually or by means of an actuator, from the top of the first stack 11 to the top of the second stack 12 (FIG. 1).

When the movement in translation has been effected, the box sensor 24 detects the absence of a box at the reference location.

The motor 14 is then driven to raise the first stack 11 and thereby to place the box that is now the first box of the first stack 11 at the reference location (FIG. 2).

Referring to FIG. 3, the operative or the machine again has a full box which, once emptied, is likewise moved in translation to the second stack 12.

FIG. 4 shows again the raising of the first box of the first stack 11 to the reference location and the corresponding lowering of the second stack 12.

FIGS. 5 and 6 show the evacuation of an additional box from the first stack in a similar manner to FIGS. 1 and 2, on the one hand, and to FIGS. 3 and 4, on the other hand.

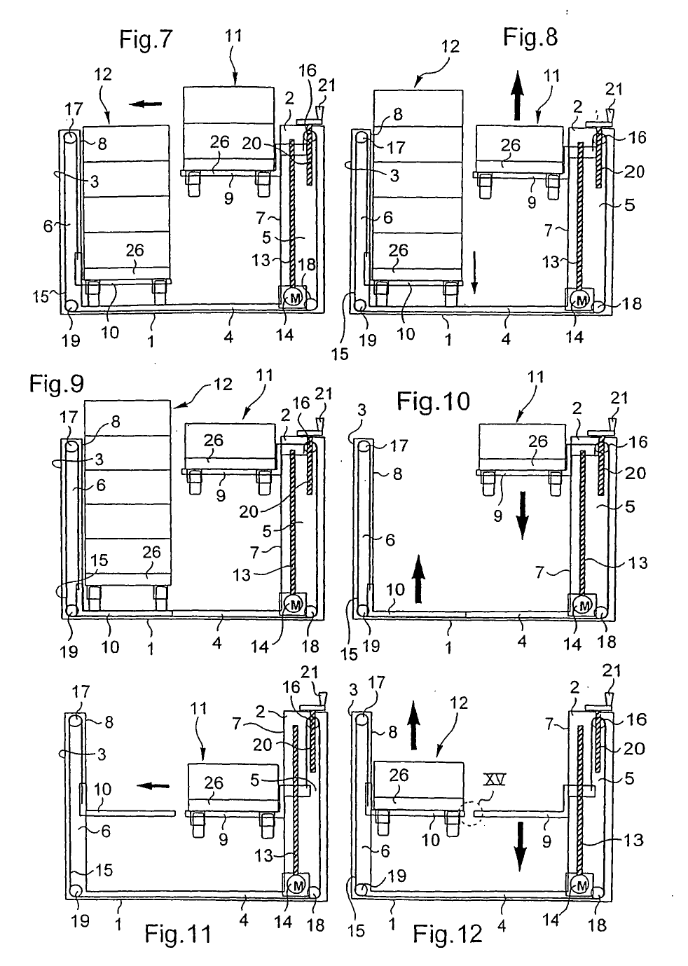

After the new full box has been put into place in the FIG. 6 step and then emptied of parts, the FIG. 7 step consists in the movement in translation of that box to the second stack 12 so that there remains only one box in the first stack 11.

The motor 14 is then driven to lower the second support 10 as far as possible and to raise the box of the first stack 11 so that the second stack 12 can be evacuated (FIGS. 8 and 9).

Thanks to the trolley 26, the second stack 10, including only empty boxes, can then be evacuated easily by the operator himself between two part picking sessions.

When the last box of the first stack 11 is empty, the motor 14 is driven, again by the operative, to lower the first support 9 until the two supports 9, 10 are facing each other (FIGS. 10 and 11). When the support sensor 23 indicates this position of the supports 9, 10, the motor 14 is stopped.

Note that, for the operative or the machine, the part picking time and the part evacuation time are interleaved. The operative or the machine can carry out handling operations between two part picking sessions and can also pick parts while the supports are moving.

When the last box of the first stack 11 is empty, it is moved in translation, again by sliding it, to the second support, which is then raised as far as possible by lowering the first support 9 at the command of the operative or the machine (FIGS. 12 and 13).

In the FIG. 13 position, the handling device is ready to receive a new first stack 11 of full boxes, which loops the cycle by returning to the FIG. 1 configuration.

In a variant that is not shown, a sensor of the absence of the second stack 12 is provided to trigger automatically the movement to the mid-height position in which the supports 9, 10 are face to face.

In another embodiment, shown in FIGS. 18 and 19, the guide path 4, 5, 6 and the cable 15 are replaced by an electronic synchronization device controlling a motor 28 associated with each of the supports.

In FIGS. 18 and 19, parts common to the previous embodiment are identified by the same number “primed”.

Referring to FIG. 18, the handling device includes a motor 28 at the top of one of the lateral uprights 2′, 3′. Each motor 28 co-operates with a strap 29 attached to the corresponding support 9′, 10′ so that the support 9′, 10′ hangs from the end of the strap 29, guided by the slideways 7′ and 8′.

Winding in the strap 29 by the motor 28 therefore raises the corresponding support 9′, 10′ whilst paying it out lowers the support 9′, 10′ by gravity.

The motors 28 are controlled by a control module 22′ that is represented in FIG. 14 and raises one of the supports 9′ at the same time as lowering the other support 10′, and vice versa, under the control of a stack height sensing member 24′ on each of the lateral uprights 2′, 3′.

As before, this simultaneous drive aims to enable the top box of one stack to be transferred directly to the other stack by movement in lateral translation, at the same level.

The control module 22′ is also connected to a second sensing member 23′ adapted, as in FIG. 15, to detect the face-to-face position of the supports 9′, 10′; in this embodiment this position can be at any height, and preferably as high as possible, as shown in FIG. 18.

Note that the safety stop member 27 is not included in the embodiment otherwise shown in FIGS. 18 and 19.

FIG. 19 shows the successive steps of winding in the strap 29 of the first lateral upright 2′, exactly the same thing happening in respect of the lateral upright 3′.

The motor 28 thus includes a winder 30 guiding the strap 29 while it is being wound in and enabling the strap 29 to be wound on itself so that as it is wound up the diameter of the rotor driving this winding increases.

Here the motor 28 has no variable speed controller because it is adapted to operate at constant torque.

Other embodiments of the handling device that do not depart from the scope of the invention may also be envisaged. In particular, means other than those described above may be used to procure the various relative movements of the supports 9, 10. For example, the cable 15 may take the form of any kind of flexible connection, metal or otherwise. Similarly, the handling device may co-operate with other types of containers than boxes, including containers for fluids.

1. A handling device for boxes and the like for repeatedly presenting the top box of a first stack (11) of boxes at a predetermined height and making it possible to remove said top box in such a way that the boxes removed from the first stack (11) gradually form a second stack (12), this device comprising:
a first vertically movable support (9) for receiving said first stack (11);
a second vertically movable support (10) for receiving said second stack (12); and
means for synchronously driving the first and second supports (9, 10) so that when one goes up the other goes down and vice versa; which handling device is characterized in that it further includes a first lateral upright (2) and a second lateral upright (3) separate from the first upright (2) each provided with a slideway (7, 8), the first support (9) being mounted on the slideway (7) of the first upright (2) and the second support (10) being mounted on the slideway (8) of the second upright (3), the device being adapted to leave free the gap between the second upright (3) and said top box of the first stack (11) at the predetermined height so that the top box of the first stack (11) is transferable directly to the second stack (12) by lateral displacement at a more or less permanent level.

2. Handling device according to claim 1, characterized in that the supports (9, 10) are further adapted to occupy a mid-height position in which they are disposed face-to-face at more or less the same level.

3. Handling device according to claim 1, characterized in that the synchronized drive means include a cable (15) each of the ends whereof is connected to a respective one of the supports (9, 10) and which travels along a guide path (4, 5, 6) including two bottom idler pulleys (18, 19) each disposed at the base of a respective one of the lateral uprights (2, 3) and two top idler pulleys (16, 17) each disposed at the top of a respective one of the lateral uprights (2, 3), the portion (4) of the guide path situated between the bottom idler pulleys (18, 19) being substantially horizontal and disposed under said supports (9, 10) so that the assembly formed by the two supports (9, 10) is partially surrounded by the guide path (4, 5, 6).

4. Handling device according to claim 1, characterized in that it further includes at least one motor (14) co-operating with transmission means (13) connected to the synchronized drive means.

5. Handling device according to claim 4, characterized in that said transmission means (13) connect the motor (14) to one of the supports (9, 10) so that the movement of said support (9) are driven directly by the motor (14), the movement of the other support (10) being driven by the synchronized drive means.

6. Handling device according to claim 4, characterized in that said transmission means include a transmission screw (13) adapted to be driven in rotation by the motor (14), the support (9) being connected to a threaded member meshing with the transmission screw (13).

7. Handling device according to claim 3, characterized in that at least one of the idler pulleys (16, 17, 18, 19) is mounted on a mobile shaft allowing movement of the pulley and modification of the length of the guide path (4, 5, 6).

8. Handling device according to claim 7, characterized in that one of the top idler pulleys (16, 17) is mounted so as to be mobile substantially vertically relative to the corresponding lateral upright (2, 3).

9. Handling device according to claim 7, characterized in that one of the top idler pulleys (16, 17) is connected to a threaded member meshing with an adjuster screw (20) rotatably mounted on the corresponding lateral upright (2, 3), the adjuster screw (20) being connected to drive means (21) accessible from said lateral upright (2, 3).

10. Handling device according to claim 1, characterized in that it further includes a control module (22) for the synchronized drive means and at least one sensing member (23, 24) connected to said control module (22), which is adapted to control the synchronized drive means as a function of indications supplied by the sensing member (23, 24).

11. Handling device according to claim 10, characterized in that it includes a member (24) for sensing the height of the first stack (11).

12. Handling device according to claim 10, characterized in that it includes a member (24) for sensing the height of the second stack (12).

13. Handling device according to claim 10, characterized in that it includes at least one support sensing member (23) adapted to supply an indication to the control module (22) when the two supports (9, 10) are face-to-face.

14. Handling device according to claim 1, characterized in that it includes a safety stop member (27) mounted under at least one of said supports (9, 10) and including stop means for the supports (9, 10).

15. Handling device according to claim 1, characterized in that the synchronized drive means include two motors (28) each disposed on one of the lateral uprights (2′, 3′).

16. Handling device according to claim 15, characterized in that the supports (9′, 10′) are further adapted to occupy a high position in which they are disposed face-to-face at more or less the same level.

17. Handling device according to claim 15, characterized in that each support (9′, 10′) is attached to the first end of a flexible connection (29) whose second end is attached to the motor (28) so that winding in of the second end of the flexible connection (29) by the motor (28) raises the support (9′, 10′).

18. Handling device according to claim 17, characterized in that the motor (28) includes a winder (30) adapted to enable the second end of the flexible connection (29) to be wound up on itself by the motor (28) so that during winding the winding diameter increases.

19. Handling device according to claim 18, characterized in that the flexible connection (29) includes a strap forming the second end of the flexible connection (29).

20. Handling device according to claim 15, characterized in that it further includes a control module (22′) of the synchronized drive means and at least one sensing member (23′, 24′) connected to said control module (22′), which controls the synchronized drive means as a function of the indications supplied by the sensing member (23′, 24′).

21. Handling device according to claim 20, characterized in that it includes two sensing members (24′) each disposed on one of the lateral uprights (2′, 3′) and each adapted to sense the height of the corresponding stack.
